(19) United States
(12) Patent Application Publication
(10) Pub. No.: US 2026/0016595 A1
(43) Pub. Date: Jan. 15, 2026

(54) METHOD AND APPARATUS FOR MULTI-RANGE TIME OF FLIGHT DETECTION

(71) Applicant: NewSight Imaging Ltd., Ness Ziona (IL)

(72) Inventors: Eyal Yatskan, Modiin (IL); Uri Baror, Modiin (IL); Yair Elmakias, Rosh Haayin (IL)

(21) Appl. No.: 18/995,201

(22) PCT Filed: Jul. 17, 2023
(86) PCT No.: PCT/IL2023/050747

§ 371 Date: Jan. 16, 2025

Related U.S. Application Data
(60) Provisional application No. 63/368,653, filed on Jul. 17, 2022.
(60) Provisional application No. 63/383,494, filed on Nov. 13, 2022.

(51) Int. Cl. G01S 17/10; G01S 7/4863; G01S 7/4865; G01S 17/931

(52) U.S. Cl. CPC G01S 17/10; G01S 7/4863; G01S 7/4865; G01S 17/931

(57) ABSTRACT

A method for detecting distance of a distant object is provided. The method includes sending at least one first pulse of light towards an object, the at least one first pulse having a first pulse width configured to detect objects at a first range of distances, detecting within at least one first time slot the first pulse reflected by objects within the first range; sending at least one second pulse of light towards the object, the at least one second pulse having a second pulse width configured to detect objects at a second range of distances. The method further includes detecting within a second time slot the second pulse reflected by objects within the second range and determining distance of the object in accordance with the detection of the first and second pulses.

### FIELD OF INVENTION

The presently disclosed subject matter relates to method and apparatus for time of flight detection, in general, and in particular to a multi-range time of flight detection.

### BACKGROUND

Vehicle autonomy and driver assistance systems rely on the ability to detect objects at various distances in relation to the vehicle, in order to determine the distance between the vehicle and the object; and in order to identify the potential objects such as pedestrians and cyclists, motor vehicles, side strips, bridge abutments, road margins, etc.

Light Detection and Ranging systems (LiDAR) are one of the technologies which are used in autonomous vehicles for assessing distances. In the LiDAR systems a target is illuminated with a pulsed laser light, and the reflected pulse is measured.

As shown in FIG. 1, The LiDAR system is configured to send out light pulses 10, such as a 50 ns pulses, which are reflected by objects in front of the system and are subsequently detected by the detector of the LiDAR system as reflected pulses 12. Due to the effect of time of flight, the reflected pulse 12 arrives back at the detector of the LiDAR system at a time delay 14, which is proportional to the distance between the LiDAR system and the detected object. The first readout of the detector is carried out at the end of each of the emitted pulses 10, e.g. at the end of the 50 ns time slot 16. Due to the delay of the reflected pulse 12, only a front section 20a of the reflected pulse 12, reaches the detector before the readout occurs. Accordingly, within the timeslot of the 50 ns pulse the detector reads only a portion 20a of the reflected pulse 12.

The remaining portion 20b of the reflected pulse 12, i.e. the portion of the reflected pulse 12 which reaches the detector after the end of the emitted pulses 10, e.g. at the end of the 50 ns time slot 16. Thus, the readout of the remaining portion 20b can be carried out at the beginning of a successive pulse 18. This way the LiDAR system obtains the portions 20b of the reflected pulse 12 which is received within the time of the emitted pulse 10, and the remaining portion 20a which is received within the time of the emitted pulse 10.

The distance can be calculated using the equation,

$$D = \frac{1}{2} c {t}_{0} \frac{{S}_{2}}{{S}_{1} + {S}_{2}}$$

for an ideal detector. Where c is the speed of light; t₀ is the time the pulse takes to travel to the target and back; S₁ is the amount of the light which is received by the detector at the timeslot of the emitted pulse 10, here designated as 20a; and S₂ is the amount of the light pulse which is detected after the end of the emitted pulse 10, here designated as 20a.

This way, the two readouts provide both components of the reflected pulse 12 S₁ and S₂, and the distance of the object can be calculated with the above equation.

However, in order to properly detect distant objects it is required to adapt the width of the pulse and the readout time in accordance with the distance range, i.e., the range in which the object to be detected is expected to be located.

U.S. Pat. No. 11,366,225 “AN IMPROVED ACTIVE-PIXEL SENSOR ARRAY” discloses a range detector for detecting distance of an object. The detector includes: a light source configured to emit a first light pulse and a second light pulse towards a distant object, the first light pulse being configured for short-range object detection and the second light pulse being configured for long-range object detection; an active pixel sensor having a plurality of pixel elements each of which including at least one photodiode and at least one floating diffusion region configured to receive photoelectric charge from the at least one photodiode, the at least one photodiode being disposed with respect to the light source, such that the first and second pulses are reflected back from the object towards the at least one photodiode; and a controller configured to actuate the light source to selectively emit the first and second light pulses and to determine distance of the object.

### SUMMARY OF INVENTION

There is provided according to one aspect of the presently disclosed subject matter a method for detecting distance of a distant object. The method includes sending at least one first pulse of light towards an object, the at least one first pulse having a first pulse width configured to detect objects at a first range of distances, detecting within at least one first time slot the first pulse reflected by objects within the first range; sending at least one second pulse of light towards the object, the at least one second pulse having a second pulse width configured to detect objects at a second range of distances. The method further includes detecting within a second time slot the second pulse reflected by objects within the second range and determining distance of the object in accordance with the detection of the first and second pulses.

The timing of the first and second time slots can be configured such that the first timeslot ends prior to time-of-flight of the first pulse to distance within the second range, and the second time slot begins after time-of-flight of the second pulse to a distance within the first range.

The first and second ranges can partially overlap and wherein timing of the first and second time slots is configured such that the first timeslot ends prior to time-of-flight of the first pulse to a distance at the center of second range, and the second time slot begins after time-of-flight of the second pulse to a distance at the center of the first range.

The distance of objects located at a distance which is within the first range and within the second range can be determined by an average of detection values obtained from the first pulse and second pulse.

The first pulse width can be configured in accordance with light attenuation of the first pulse reflected by objects within the first range and wherein the second pulse width is configured in accordance with light attenuation of the second pulse reflected by objects within the second range.

The at least first pulse can include a first series of first pulses and wherein the at least second pulse includes a second series of second pulses and wherein number of pulses in the first and second series is determined in accordance with attenuation of the pulses during time-of-flight to the first and second ranges.

The first series of pulses can be detected during the at least one first time slot.

The at least one first time slot can include a plurality of first timeslots and wherein each pulse in the first series of pulses is detected during one of the first timeslots.

The method can further include detecting ambient light prior to at least the first or second pulses, the ambient light is detected within an ambient timeslots having a duration determined in accordance with the first and second pulse width.

There is provided according to another aspect of the presently disclosed subject matter a range detecting apparatus for detecting distance of an object. The apparatus includes a light source configured to emit at least one first pulse of light and at least one second pulse of light towards a distant object, the at least one first pulse having a first pulse width configured to detect objects at a first range of distances and the second pulse having a second pulse width configured to detect objects at a second range of distances. The range detecting apparatus further includes a detector configured to detect within at least one first time lot the first pulse reflected by objects within the first range and to detect within at least one second timeslot the second pulse reflected by objects within the second range. The range detecting apparatus further includes a controller configured to actuate emittance of the first and second pulses from the light source and to control detection of the detector during the first and second timeslots, and to determine distance of the object in accordance with the with detection of the first and second pulses.

The controller can be configured to determine timing of the first and second time slots such that the first timeslot ends prior to time-of-flight of the first pulse to distance within the second range, and the second time slot begins after time-of-flight of the second pulse to a distance within the first range.

The first and second ranges can partially overlap and the timing of the first and second time slots is configured such that the first timeslot ends prior to time-of-flight of the first pulse to a distance at the center of second range, and the second time slot begins after time-of-flight of the second pulse to a distance at the center of the first range.

The controller can be configured to determine the first pulse width in accordance with light attenuation of the first pulse reflected by objects within the first range and to determine second pulse width in accordance with light attenuation of the second pulse reflected by objects within the second range.

The at least first pulse can include a first series of first pulses and wherein the at least second pulse includes a second series of second pulses and wherein number of pulses in the first and second series is determined in accordance with attenuation of the pulses during time-of-flight to the first and second ranges.

The detector can include a pixel array having a plurality of groups of pixels, wherein each group includes at least one first pixel configured for accumulation of a first number of pulses out of the first and second series of pulses and at least one second pixel configured for accumulation of a second number of pulses out of the first and second series of pulses.

The detector can be configured to detect ambient light prior to the first and second timeslots.

The ambient light can be detected with all the pixels in the groups.

Each group in the pixel array can include two first pixels for detecting a front portion and a back portion of the first and second pulses and two second pixels for detecting a front portion and a back portion of the first and second pulses.

### BRIEF DESCRIPTION OF THE DRAWINGS

In order to understand the disclosure and to see how it may be carried out in practice, embodiments will now be described, by way of non-limiting examples only, with reference to the accompanying drawings, in which:

FIG. 1 is a is a graph illustration of the prior art time-of-flight reflected light detection;

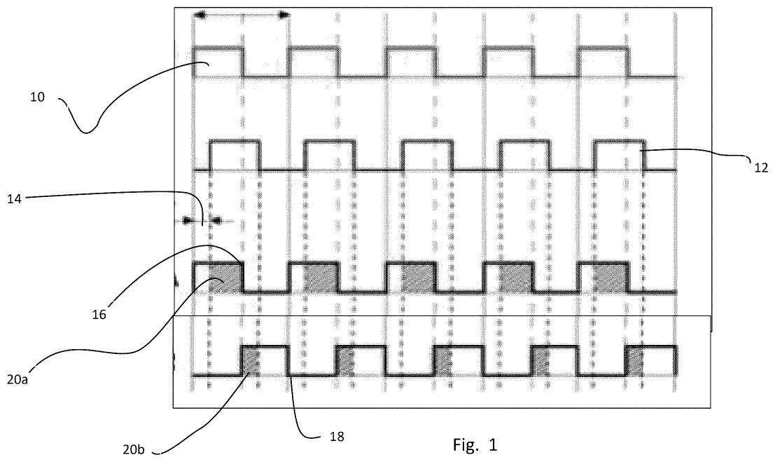

FIG. 2 is a block diagram of the apparatus in accordance with an example of the presently disclosed subject matter;

exploded view of the apparatus of FIG. 1A;

FIG. 3 is a graph illustration of light pulse detection in accordance with an example of the presently disclosed subject matter;

FIG. 4 is a graph illustration of light pulse detection in accordance with another example of the presently disclosed subject matter;

FIG. 5 is a schematic illustration of a pixel sensor arrangement in accordance with another example of the presently disclosed subject matter;

FIG. 6 is a graph illustration of light pulse detection in accordance with yet another example of the presently disclosed subject matter; and

FIGS. 7A and 7B are schematic illustrations of a settings of pixel sensor arrangement in accordance with an example of the presently disclosed subject matter.

### DETAILED DESCRIPTION OF EMBODIMENTS

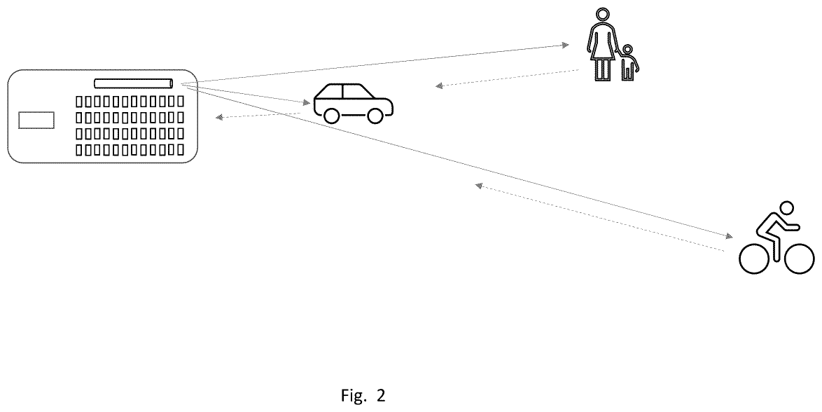

As shown in FIG. 2, the apparatus 25 for detecting and determining distances of objects includes a light source 27 configured to emit light pulses towards the objects. The apparatus 25 further includes a detector 28, such as an active pixel array, which is configured to detect reflecting pulses of light reflected by the objects. For example, the apparatus 25 can be mounted on a vehicle and can be configured to emit various pulses to detect objects in the soundings of the vehicle. The light source 27 is configured to emit pulses of various ranges, such as a first pulse 32a for detecting an object at a first distance, here illustrated as a car 29a. The light source 27 is further configured to emit a second pulse 32b for detecting an object at a second distance, here illustrated as a pedestrians 29b. Similarly, the light source 27 can be further configured to emit a third pulse 32c for detecting an object at a third distance, here illustrated as a bicycle 29c. it will be appreciated that the light source 27, can be configured to emit more pulses for detecting objects and various distances.

Each one of the light pulses 32a-32c is configured to reach the associated object 29a-29c, and to be reflected back towards the apparatus 25. The light pulses 32a-32c are thus configured such that the reflected pulses 34a-34c can be detected by the detector 28.

Since the objects 29a-29c are disposed at various distances, each one of the pulses 32a-32c is configured in accordance with the distance of the associated object. For example, in order to detect the bicycle 29c, disposed at a relatively long distance from the apparatus 25, the third light pulse 32c has a larger pulse width relative to the pulse width of the first light pulse 32a. This way the amount of light in the third pulse 32c has sufficient energy to reach the bicycle 29c, and the third reflected pulse can reach the apparatus 25 and can be detected by the detector 28. Thus, the apparatus 25 is provided with a controller 23, configured to control the width of the light pulses 32a-32c.

The detector 28 is configured to detect the light pulses and measure the time-of-flight of each of the light pulses 32a-32c by measuring the amount of light in the associated reflected pulses 34-34c. The time-of-flight (TOF) is measured by detecting the reflected light pulses 34-34c within a predetermined timeslot, such that distance of the object is calculated in accordance with the amount of light detected during the timeslot, relative to the amount of light in the pulse. The term amount of light is referred to the amount of light energy in the pulse, and the amount of light energy which reaches the detector 28.

However, since each of the light pulses 32a-32c has a predetermined pulse width, the detection timeslot for detecting each of the reflected pulses 34-34c is configured accordingly. That is to say, controller 23 is configured also to control the length of the detection timeslot for detecting each of the reflected pulses 34-34c. The controller 23 is further configured to control the timing of each of the detection timeslots with respect to the timing of the associated light pulses 32a-32c. In other words, the controller determines the duration of each timeslot as well as the timing of the timeslot with respect to the timing of the pulse.

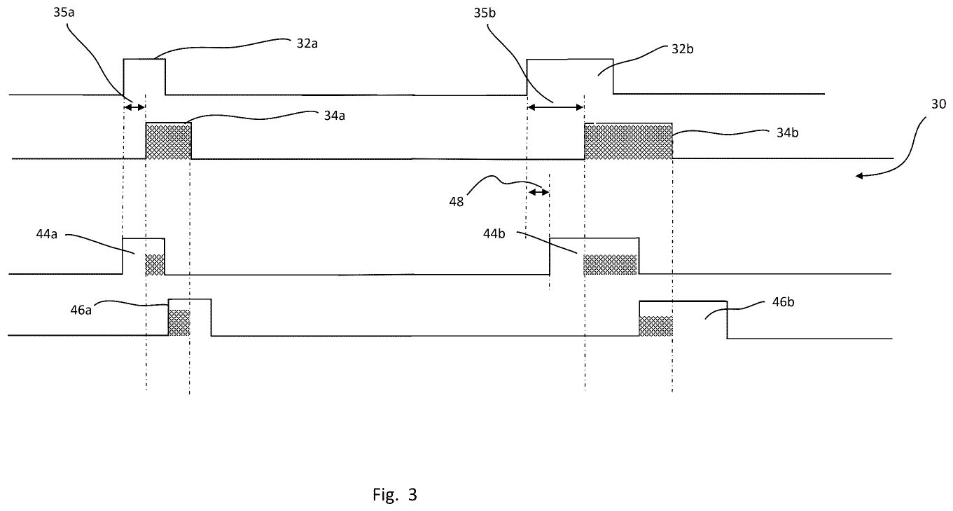

An example of the timing of the light pulses 32a-32b and the detection timeslot is shown in the graph representation of FIG. 3. The first light pulse 32a is emitted at a certain instance of time and has a first pulse width. As indicated hereinabove the first pulse width is configured to reach and be reflected by a first object, as the car 29a, disposed at a first distance. The associated reflected pulse 34a reaches the detector 28 with a slight delay 35a with respect to the pulse, due the time-of-flight of the first light pulse 32a from the apparatus 25 towards the car 29a, and time-of-flight of the first reflected pulse 34a back to the apparatus 25.

The detector 28 is configured to detect the reflected pulse 34a with two detection timeslots, a front timeslot 44a, for detecting the front portion of the reflected pulse, and back timeslot 46a for detecting the back portion of the reflected pulse. Readout of the accumilcated energy is carried out at the end of each timeslot.

Readout of the accumulated energy is carried out at the end of each timeslot. In other words, the first readout of the detector is carried out at the end of the first pulse 32a, e.g., at the end of the 30 ns timeslot 44a. Due to the delay of the reflected pulse 34a, only a front section of the reflected pulse 34a, reaches the detector before the readout occurs. Accordingly, within the timeslot of the 30 ns pulse the detector reads only a portion of the reflected pulse 34a. The remaining portion of the reflected pulse 34a, is detected during the backend timeslot 46a, and thus the readout at the end of the backend timeslot 46a includes only energy accumulated during the backend timeslot 46a.

Accordingly, the distance can be calculated using the equation, D=½c t₀S₁+S₂/S₂ for an ideal detector. Where c is the speed of light; t₀ is the pulse width; i.e. the pulse duration; S₁ is the amount of the light of the reflected pulse 34a detected during the front timeslot 44a; and S₂ is the amount of the light of the reflected pulse 34a detected during the back timeslot 46a.

In this connection the pulse width t₀ determines the maximum range the apparatus 25 can handle, i.e., the maximum distance of the range within the object is expected to be located. In other words, for detecting car 29a located within the range of 0-4.5 m with respect to the apparatus 25, the t₀ is calculated as:

$${D}_{max} = \frac{1}{2} c {t}_{0}$$

Thus, for maximum distance of 4.5 m the pulse width is 30 ns.

Further, the apparatus detects distance of the second object 29b disposed at the second distance, which is out of the 0-4.5 m, detected with the first pulse 32a. The second object 29b is thus detected with a second light pulse 32b which is emitted after the detection of the first reflected pulse 34a is completed. The associated second reflected pulse 34b reaches the detector 28 with a delay 35b, which is larger than delay 35a of the first reflected pulse 34a. This is due to the longer time-of-flight of the second light pulse 32b from the apparatus 25 towards the second object 29b, and longer time-of-flight of the second reflected pulse 34b back to the apparatus 25.

Just as with the first reflected pulse 34a, the detector 28 detects the second reflected pulse 34b with two detection timeslots, a front timeslot 44b, for detecting the front portion of the reflected pulse, and back timeslot 46b for detecting the back portion of the reflected pulse.

As shown, the second light pulse 32b has a pulse with larger than the pulse width of the first light pulse 32a. as indicated above this width is determined in accordance with the maximum range the detector is expected to detect with the second light pulse 32b. I.e., the maximum distance of the range within the second object is expected to be located.

Thus, for detecting the second object 29b located within the range of 2-11 m with respect to the apparatus 25, the t₀ is calculated as:

$${D}_{max} = \frac{1}{2} c {t}_{0}$$

Thus, for maximum distance of 11 m the pulse width can be about 73.3 ns. However, it is noted that since the required detection range has a minimum range of 2 m, there is no need for such a long pulse. Instead, the second reflected pulse 34b can be detected with a slight delay 48 with respect to the time of the second pulse 32b. This is unlike the detection of the first reflected pulse 34a in which the front timeslot 44a started together with the first pulse 32a. This delay 48 can be calculated again by using the above equation, and calculating the pulse width required for detecting an object at a distance of 2 m, i.e., about 13.3 ns.

Consequently, the pulse width required for detecting the second object 29b located within the range of 2-11 m is 60 ns. It would be understood that this delay compensates for the minimum time required for the pulse to return after being reflected by the second object. In other words, during this delay 48 no light of the second reflected pulse is expected to be detected.

Just like with the first reflected pulse, the remaining portion of the second reflected pulse 34b, is detected during the second backend timeslot 46b, and the distance of the second object 29b can be calculated using the equation,

$$D = \frac{1}{2} c {t}_{0} \frac{{S}_{2}}{{S}_{1} + {S}_{2}} .$$

Thus, the width of the second pulse and its power are configured to detect objects within a predetermined range of distances.

Although not shown here, it would be appreciated that a third pulse to detect the third object 29c can be configured in a similar manner. For example, in order to detect an object located within a third range of distances of 8 m-20 m, the width of the third pulse and the start time thereof are calculated with:

$${D}_{max} = \frac{1}{2} c {t}_{0}$$

i.e., the maximum pulse width for detecting an object located at a distance of 8 m is 53.3 ns, and the maximum pulse width for detecting an object located at a distance of 20 m is 133.3 ns. Hence, the pulse width required for detecting objects within the range of 8 m-20 m is 80 ns.

It would be appreciated that the range of distances can be configured with overlap portions, such that distance of objects located at the edges of the range can be most accurately determined. For example, if the first object 29a is located at a first distance of 3 m from the apparatus 25, the first pulse 32a having a pulse width of 30 ns is configured to detect objects within the range of 0 m-4.5 m, including the first object 29a. At the same time, the second pulse 32b having a pulse width of 60 ns and a start point of 13.3 ns is configured to detect objects within the range of 2 m-11 m, including the first object 29a as well as the second object 29b.

Similarly, the third pulse 32c having a pulse width of 80 ns and a start point of 53.3 ns is configured to detect objects within the range of 8 m-20 m, including the second object 29b as well as the third object 29c.

In view of the above, the distance of each of the objects 29a-29c can be determined by the results obtained by all the pulses. Namely, if the object is detected by one of the pulses, the distance is determined by the result of the detecting pulse. However, in case the object is detected by more than one pulse, the distance is determined by the results of all the detecting pulses. This can be carried out for example by either averaging the calculated distances obtained by each of the pulses.

According to an example, determining the distance of objects detected by more than one pulse can be carried out by assessing the amount of light detected for each pulse. That is to say, since each of the reflected pulses 34a and 34b may be only partially detected, depending on the amount of energy obtained by the detector 28, assessment of the distance can take into consideration the amount of energy detected for each of the pulses 32a and 32b. For example, in case the first object 29a is detected by the first and second pulses 32a and 32b, however the amount of energy received by the pixels of the detector 28 is higher for the second pulse 32b, the distance of the first object 29a can be determined only by the second pulse 32b. Alternatively, the distance of the first object 29a can be determined by using weighted average, considering the detected distances according to each of the pulses and the amount of energy of each of the pulses.

It is noted that although in the above example, the first and second ranges include a relatively large overlapping portion, according to other examples the various ranges may include a smaller overlapping portion. That is to say, in the above example, the detection of the second reflected pulse 34b is carried out by the second front and back timeslots 44b and 46b after a predetermined delay 48. As explained above the length of the delay 48 is determined such that light reflected from closer objects is not detected. In the above example, light reflected from objects disposed in the range of 0 m-2 m will not be detected during the second front and back timeslots 44b and 46b. On the other hand, objects located in the range of 2 m-4.5 m, according to this example would be detected by first timeslots 44a and 46a as well as by the second timeslots 44b and 46b. As explained above, this overlapping portion allows receiving data regarding the distance of the objects by more than one pulse and determining the distance by the results of all the detected pulses.

According to another example, the overlapping portions can be reduced only to the edges of each reflected pulse. Namely, since each reflected pulse is detected by a front timeslot and a back timeslot, pulse received at the end of the first front timeslot during the detection of the first range may detect very low and insufficient light energy. Accordingly, the pulses of the consequent range, can be configured to slightly overlap, such that the second front timeslot receives the pulse which was not properly detected by the first front timeslot.

It would be appreciated that the distance calculation can further include setting a minimum threshold of energy value in the pixel, such that pixels with energy value below the threshold are not included in the distance calculation. This way, background noises can be eliminated, and the distance can be most accurately assessed. Moreover, the minimum threshold can be determined in accordance with the pulse width, such that for example, the first pulse 32a has a higher threshold than the threshold of the third pulse 32c. This way, the threshold is determined in accordance with the expected distance the pulse is expected to travel, and the resulting light scattering and energy attenuation of the reflected pulse.

Furthermore, the apparatus 25 can be configured to emit a series of pulses for a certain range of distances. For example, for the third pulse 32c which is configured to detect objects within the range of 8 m-20 m, the controller 23 can be configured to emit multiple third pulses 32c, i.e., multiple pulses having a pulse width of 80 ns. The series of pulses can be sent one after the other and the detector 28 can be configured such that each of the pulses is detected with a front timeslot and a back timeslot, as described above. The detector 28 is further configured to accumulate the charges for each of the pulses in the series of pulses. This way, the overall light energy for the third pulse 32c can be increased without increasing the pulse width of each of the pulses 32c. In other words, the apparatus 25 allows to dynamically determine the number of pulses for detecting each of the ranges, so as to compensate for energy losses. The controller 23 can be configured to determine the minimal accumulation required for obtaining a proper data from the reflected pulses.

It would be appreciated that the number of pulses may vary in accordance with the light decay for each specific instance. For example, if weather conditions are such that the reflected pulses are weak, the controller 23 can be determined to increase the number of pulses so as to accumulate charges from more reflected pulses and to obtain a reliable data.

Moreover, detection in multiple ranges can be configured with other parameters characterizing each of the ranges. That is to say, if light conditions in a first distance range is different than light conditions in a second distance range, the pulses or the detection can be configured to dynamically conform with the light conditions for each of the ranges. For example, if in a first range ambient light is low, the sensitivity of the detector 28 can be configured with a low threshold. For a second range on the other hand, in which ambient light is high, the sensitivity can be adapted accordingly. This way, if an image of multiple objects is obtained, where some of the objects are positioned in the shade and other objects are located in the sun, the multiple range detection system can be configured to detect distances of the objects in multiple range pulses taking into consideration the lighting conditions at each range.

It would be appreciated that the use of varying sensitivities in multiple ranges allows obtaining images in a dynamic range. I.e., detecting a first range of light intensities during the first distance range, and detecting a second range of light intensities during the second distance range. This way, the detector can detect objects with high reflectivity disposed at a close distance, and at the same time detect objects with low reflectivity disposed at a far distance. Moreover, according to the present invention, utilizing multi range pulses which are detected in multi timeslots, as described hereinabove allows detection of objects in fog conditions. That is since fog reflects light pulses in a short range, while the pulses reflected by objects are in a relatively longer range.

Under these fog conditions first light pulse 32a is emitted with a predetermined pulse width and reflected pulse 34a reflected by fog is detected by the detector 28 within the first front and back timeslots 44a and 46a. Obviously, due to the fog all the pixels in the detector would detect reflected light, as opposed to light reflected from a single object.

However, in such a scenario, a second light pulse 32b can be emitted with a longer pulse width and the detector 28 can be configured to detect the reflected pulse 34b with a delay. The delay can be configured such that the detection by the second front and back timeslots 44b and 46b is initiated only after the light reflected by the fog already reached the detector. For example, using the range values described above, if the detection starts 13.3 ns after the pulse is sent, all the light reflected by fog within 4.5 m will not be detected by the detector, and the detector will only detect light reflected by the object located out of the range of the fog.

According to an example of the present invention, the multi range time of flight detection can be utilized in other systems, such as augmented reality systems, face recognition etc. For example, in augmented reality systems, it is required to integrate virtual reality objects in real world environment, thus depth measurements of objects in various distances are required. For example, an augmented reality furniture placement system in which the user is provided with a 3D image of an imaginary furniture placed in a real-world room. Hence, it is required to obtain real depth measurements of other objects in the room so that the size of the imaginary furniture and its integration in the image reflects the size of the room and other objects in the room.

The method and apparatus of the present invention allows obtaining depth and distance measurements of objects located in various ranges of distances.

In addition, for face recognition systems, present systems are configured to detect faces at a predetermined range of distances. That is to say, the pulse width and the detection timing are configured for a specific range, and people passing outside the range are not detected properly. The method and apparatus of the present invention allow distance and depth detection in multiple ranges such that faces can be identified in multiple ranges.

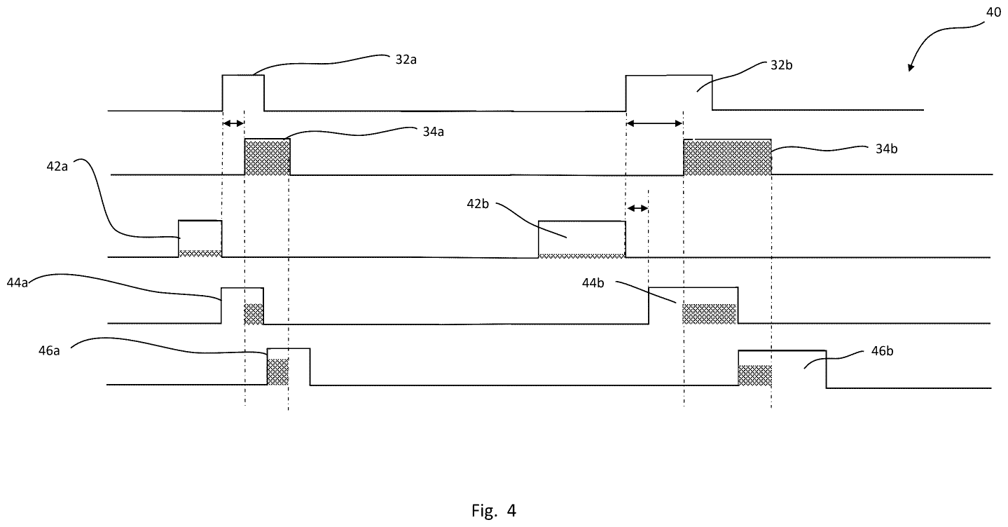

According to another example, the detector 28 can be further configured to detect background light before the detection of each of the pulses. As shown in FIG. 4, the timing graph 40 of the light pulses 32a-32b includes reflected pulses 34a and 34b as well as front timeslots 44a and 44b, for detecting the front portions of the reflected pulses, and back timeslots 46a and 46b for detecting the back portions of the reflected pulses.

According to this example, an ambient timeslot 42a can be included for detecting ambient light without any pulse light. These ambient timeslots 42a and 42b can be initiated before each of the pulses 32a and 32b, or at least before the beginning of the front timeslots 44a and 44b. This way, the ambient light at the time of each of the pulse can be detected and can be utilized as a baseline to eliminate the influence of the ambient light on the detection of the reflected pulses 34a and 34b. As shown, the duration the ambient timeslot 42a is the same at the duration of the front timeslots 44a, and the duration the ambient timeslot 42b is the same at the duration of the front timeslots 44b. This way, each of the ambient timeslots 42a and 42b the baseline for the respective reflected pulses 34a and 34b.

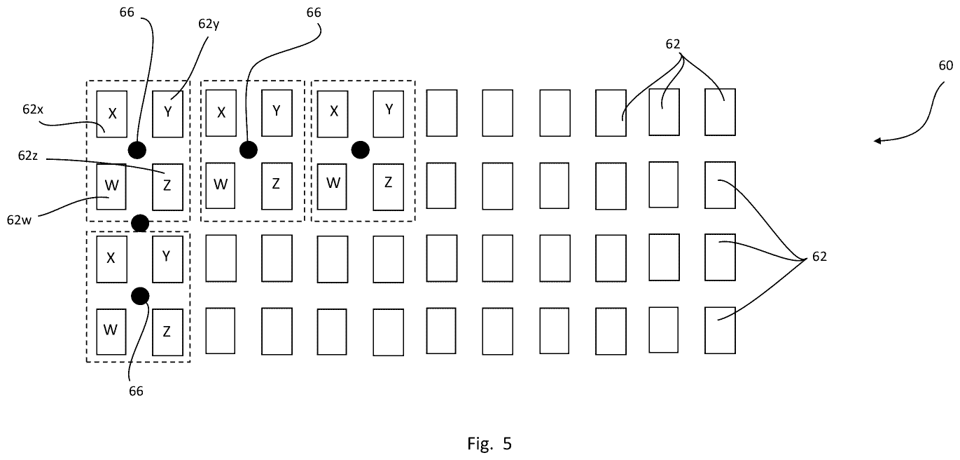

As shown in FIG. 5, the detector 28 can include an array 60 of pixels arranged in a two-dimensional array. The pixels can be grouped into plurality of groups 66 each including four pixels 62 are configured to detect light radiation. The photodiode array 60 can include a controller for determining the readout time of each of the pixels 62.

According to an example the pixels in the array 60 can be configured such that the readout of each of the pixels 62 is carried out at a predetermined time, thereby providing a predetermined exposure timeslot for each pixel, i.e., timeslot in which the pixel detects light. For example, pixels X in each of the groups 66 can be configured to detect light at a front timeslot, as described above, pixels Y in each of the groups 66 can be configured to detect light at a back timeslot. Similarly, pixels W in each of the groups 66 can be configured to detect light at a third timeslot, such as for detecting ambient light before the pulse is sent.

Moreover, pixels Z in each of the groups 66 can be configured to detect light at a fourth timeslot, for example for detecting light reached during the front and back timeslot together. As a result, the pixels Z can configured to detect the portions of reflected pulse, which is equals to the sum of the front and back portions detected by the pixels X and pixels Y.

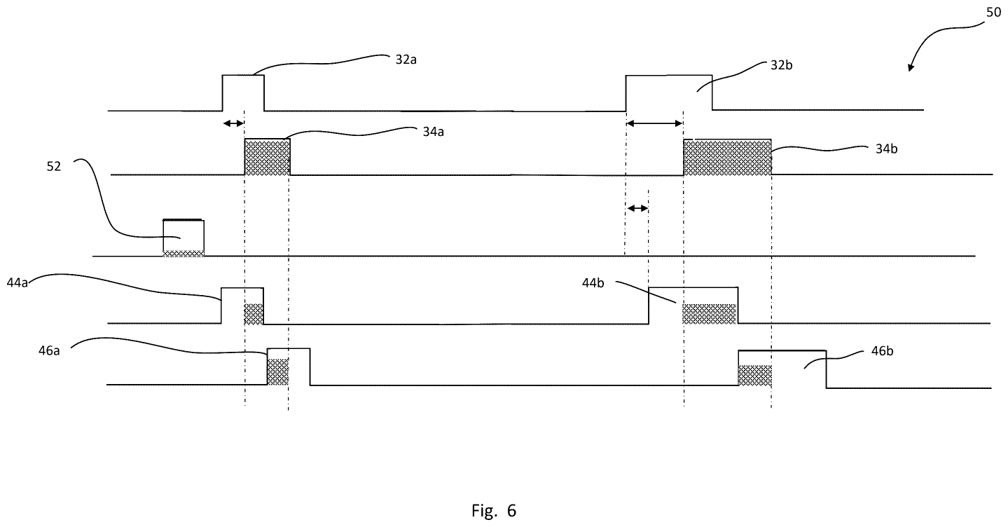

According to yet another example, the detector 28 can be configured to detect background light only once before the detection of all the pulses 32a-32b. This is contrary to the example of FIG. 4, in which the background light is detected before each of the pulses 32a and 32b in respective ambient timeslots 42a and 42b. As shown in FIG. 6, the timing graph 50 of the light pulses 32a and 32b includes reflected pulses 34a and 34b as well as front timeslots 44a and 44b, for detecting the front portions of the reflected pulses, and back timeslots 46a and 46b for detecting the back portions of the reflected pulses.

According to this example, a single ambient timeslot 52 can be included for detecting ambient light before sending the pulses 32a and 32b. This ambient timeslot 52 can be configured with a duration which is the same as the duration of the front timeslots 44a, i.e., the duration of the first light pulse 32a. Thus, the baseline for the first reflected pulse 34a is the ambient light detected during ambient timeslot 52. For the second reflected pulse 34b, the baseline can be determined in accordance with the ratio between the durations of the two front timeslots 44a and 44b. For example, if the first timeslot 44a is 30 ns and the second timeslot 44b is 60 ns (i.e., ratio of 1/2), the baseline for detecting the second reflected pulse 34b can be determined by multiplying the ambient light detected during ambient timeslot 52 by 2.

Alternatively, the ambient timeslot 52 can be configured with a duration which is the same as the duration of the front timeslots 44b, i.e., the duration of the second light pulse 32b. Thus, the baseline for the second reflected pulse 34b is the ambient light detected during ambient timeslot 52. For the first reflected pulse 34a, the baseline can be determined in accordance with the ratio between the durations of the two front timeslots 44a and 44b. I.e., for the above example, the baseline for detecting the first reflected pulse 34a can be determined by dividing the ambient light detected during ambient timeslot 52 by 2.

It would be further appreciated that the duration of the ambient timeslot 52 can be configured in accordance with the expected amount of ambient light. That is to say, in a case of low ambient light, it would be better to have an ambient timeslot 52 with a longer duration, otherwise, the detector may not detect any ambient light. As explained above, the detected ambient light can be used for determining the baseline for each of the first and second reflected pulses 34a and 34b, in accordance with the ratio between the duration of the ambient timeslot 52 and each of the reflected pulses 34a and 34b. Hence, the detector can be configured to dynamically determine the desired duration of the ambient timeslot 52 in accordance with the ambient light conditions.

It would be appreciated that using a single ambient timeslot 52 before sending a series of pulses of various ranges allows gaining a better frame rate and improves the detection. This is since, each detection of ambient timeslot involves inaccuracies due to the function of the electronic components of the detector.

Marking reference again to FIG. 5, when implementing the example of FIG. 6, the array 60 such that the ambient light is detected by all the pixels in of the groups 66. This is since, the ambient light is determined before the series of pulses 32a, 32b and 32c is emitted.

On the other hand, since ambient light is detected only once and during the detection of the reflected pulses 34a and 34b ambient light is not detected, all the pixels in each of the groups 66 can be configured to detect the reflected pulses, improving thereby the detection. This is contrary to the above description, in which pixels W in each of the groups 66 is utilized for detecting ambient light.

According to one example, pixels X and Y in each of the groups 66 can be configured to detect light at a front timeslot, and pixels X and W in each of the groups 66 can be configured to detect light at a back timeslot. This way, detection of each of the front portion and back portion of the reflected pulses 34a and 34b is improved.

Moreover, pixels X and Y can be configured to detect light at different accumulations. As explained above, the apparatus 25 can be configured to emit multiple pulses for each of the ranges, and the detector 28 can be configured to accumulate the charges for each of the ranges. The accumulation can be determined to conform with the light conditions for each of the ranges, such for low light conditions, high accumulation is used, and for conditions with high light reflection, low accumulation is used.

Thus, pixels X in each of the groups 66 can be configured to accumulate charges at a higher rate than the corresponding pixels Y. For example, pixels X can be configured to accumulate 10,000 iterations of the reflected pulses during the front timeslots 44a and 46a, while pixels Y can be configured to accumulate only 5,000 iterations during the same front timeslots. Similarly, pixels W can be configured to accumulate 10,000 iterations of the reflected pulses during the back timeslots 44b and 46b, while pixels Z can be configured to accumulate only 5,000 iterations during the same back timeslots.

Accordingly, when determining the light of the front and back timeslots, both accumulations are taken into consideration. For example, if pixels X are saturated due to high light reflection, the charges accumulated pixels Y are used, since pixels Y are configured to accumulate less charges and thus are less sensitive. On the contrary, in case, of low light conditions, the charges accumulated by pixels Y are not sufficient, the charges accumulated pixels X are used. It is noted that in case, both pixels X and Y, provide proper reading of the charges, the amount of light can be determined by an average of the charges in pixels X and Y.

This way, the detector 28 can detect objects with varying reflection properties and at varying light conditions.

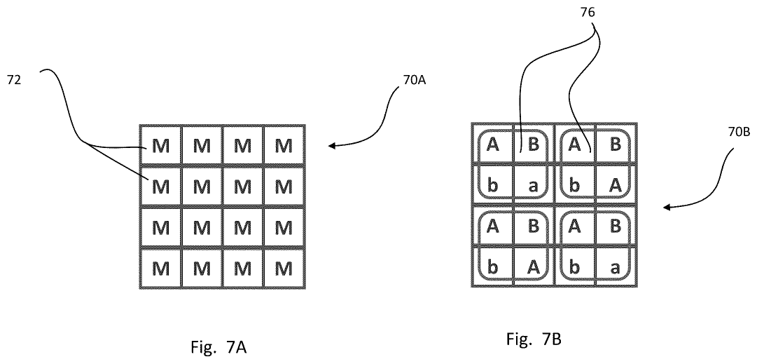

The detector can include a controller configured to determine various subframes, such that in which subframe each pixel in the array detects light in accordance with a predetermined properties. For example as shown in FIG. 7A, the pixel array, can be configured such that at the initial sub-frame 70A all the pixels 72 detect the ambient light, designated by M. On the other hand, during the pulses detection, the pixel array is configured in another subframe 70B, in which each of the groups 76 includes a pixel A which detect the front portion of the reflected pulse at a high accumulation, and a pixel a which detect the front portion of the reflected pulse at a low accumulation. Similarly, each of the groups 76 includes a pixel B which detect the back portion of the reflected pulse at a high accumulation, and a pixel b which detect the back portion of the reflected pulse at a low accumulation. The arrangement of the pixels in each group is such that allows demosaicing thereby compensating for pixels which do not provide proper data. i.e., compensating for missed data in one of the pixels, by the data received from its neighboring pixels.

According to a further example, the apparatus can include two sets of pixel array, the first pixel array being configured for a short-range detection, and the second for a long range detection. As explained above, the light pulses can include a series of pulses, such that the pixels accumulate charges of a series of reflected pulses. Accordingly, according to this example the apparatus can be configured to emit a series of pulses, for example 10,000 pulses, and the first pixel array can be configured to accumulate the first group 5000 reflected pulses, while the second pixel array can be configured to accumulate the second group of 5000 reflected pulses. This way, while the first pixel array obtains data related to pulses reflected from objects in the short range, the second pixel array obtains data related to pulses reflected from objects in the long range.

It is noted that detecting pulses reflected by objects in long distance can be carried out by sending separate pulses, as explained hereinabove with respect to FIG. 3. According to the example of FIG. 3, the second pulse 32b for detecting objects in the long range can be sent only after the first pulse 32a is reflected back by objects in the short range. However, according to the example of utilizing two separate arrays, the pulses for detecting objects in the long range are the same as those for detecting objects in the short range and no separate pulses are required. Instead, the accumulation rate of the first pixel array aims to detect objects in the short range, and the accumulation rate of the second pixel array aims to detect objects in the long range. This allows overlapping operation of the two arrays and improves the frame rate.

It would be appreciated that the, just like in the example of FIG. 3, the apparatus can be configured to emit pulses for various distances, for example, short, medium and long. The second pixel array can be configured for detecting objects in a very far distance, i.e., in a forth range, without compromising on the frame rate. In other words, objects in the very long range can be simultaneously detected by the second pixel array while the first array detects objects from the short range.

As explained above detection of the reflected pulses can be carried out with two detection timeslots, i.e., a front timeslot, for detecting the front portion of the reflected pulse, and back timeslot for detecting the back portion of the reflected pulse. Thus, it is required to detect charges received only during the respective timeslot. For example, the pixel array can be constructed such that at the beginning of each of the timeslot the active area of the pixel is emptied out of all the charges by draining the charges. At the end of the timeslot, on the other hand, the charges collected in the active area of the pixel are transferred to charges reading device, such as an analog to digital converter. This way, the amount of charges received during each of the timeslots can be detected.

According to an example of the present invention, accumulation of charges over a series of pulses is carried out by detecting reflected pulses for each of the pulses in the series. Accordingly, the accumulation is carried out with a plurality of front and back timeslots, such that each pulse is detected by a pair of front and back timeslots. In order to allow accumulation of charges over a plurality of timeslots, it is required to transfer the charges received during each timeslot to a storing component. According to an example, each of the pixels includes a capacitor to which charges of each timeslot can be transferred. At the end of the predetermined series of pulses, all the charges accumulated inside the capacitor are read by an analog to digital converter.

Those skilled in the art to which the presently disclosed subject matter pertains will readily appreciate that numerous changes, variations, and modifications can be made without departing from the scope of the invention, mutatis mutandis.

1. A method for detecting distance of a distant object, the method comprising:
sending at least one first pulse of light towards an object, said at least one first pulse having a first pulse width configured to detect objects at a first range of distances;
detecting within at least one first time slot said first pulse reflected by objects within said first range;
sending at least one second pulse of light towards the object, said at least one second pulse having a second pulse width configured to detect objects at a second range of distances;
detecting within a second time slot said second pulse reflected by objects within said second range; and
determining distance of said object in accordance with the detection of said first and second pulses.

2. The method according to claim 1 wherein timing of said first and second time slots is configured such that said first timeslot ends prior to time-of-flight of said first pulse to distance within said second range, and said second time slot begins after time-of-flight of said second pulse to a distance within said first range.

3. The method according to claim 1 wherein said first and second ranges partially overlap and wherein timing of said first and second time slots is configured such that said first timeslot ends prior to time-of-flight of said first pulse to a distance at the center of second range, and said second time slot begins after time-of-flight of said second pulse to a distance at the center of said first range.

4. The method according to claim 3 wherein distance of objects located at a distance which is within said first range and within said second range is determined by an average of detection values obtained from said first pulse and second pulse.

5. The method according to claim 1 wherein said first pulse width is configured in accordance with light attenuation of said first pulse reflected by objects within said first range and wherein said second pulse width is configured in accordance with light attenuation of said second pulse reflected by objects within said second range.

6. The method according to claim 1 wherein said at least first pulse includes a first series of first pulses and wherein said at least second pulse includes a second series of second pulses and wherein number of pulses in said first and second series is determined in accordance with attenuation of said pulses during time-of-flight to said first and second ranges.

7. The method according to claim 6 wherein said first series of pulses is detected during said at least one first time slot.

8. The method according to claim 6 wherein said at least one first time slot includes a plurality of first timeslots and wherein each pulse in said first series of pulses is detected during one of said first timeslots.

9. The method according to claim 1 further comprising detecting ambient light prior to at least said first or second pulses, said ambient light is detected within an ambient timeslots having a duration determined in accordance with said first and second pulse width.

10. A range detecting apparatus for detecting distance of an object, the apparatus comprising:
a light source configured to emit at least one first pulse of light and at least one second pulse of light towards a distant object, said at least one first pulse having a first pulse width configured to detect objects at a first range of distances and said second pulse having a second pulse width configured to detect objects at a second range of distances;
a detector configured to detect within at least one first time lot said first pulse reflected by objects within said first range and to detect within at least one second timeslot said second pulse reflected by objects within said second range;
a controller configured to actuate emittance of said first and second pulses from said light source and to control detection of said detector during said first and second timeslots, and to determine distance of the object in accordance with the with detection of said first and second pulses.

11. The range detecting apparatus according to claim 10 wherein said controller is configured to determine timing of said first and second time slots such that said first timeslot ends prior to time-of-flight of said first pulse to distance within said second range, and said second time slot begins after time-of-flight of said second pulse to a distance within said first range.

12. The range detecting apparatus according to claim 10 wherein said first and second ranges partially overlap and wherein timing of said first and second time slots is configured such that said first timeslot ends prior to time-of-flight of said first pulse to a distance at the center of second range, and said second time slot begins after time-of-flight of said second pulse to a distance at the center of said first range.

13. The range detecting apparatus according to claim 10 wherein said controller is configured to determine said first pulse width in accordance with light attenuation of said first pulse reflected by objects within said first range and to determine second pulse width in accordance with light attenuation of said second pulse reflected by objects within said second range.

14. The range detecting apparatus according to claim 10 wherein said at least first pulse includes a first series of first pulses and wherein said at least second pulse includes a second series of second pulses and wherein number of pulses in said first and second series is determined in accordance with attenuation of said pulses during time-of-flight to said first and second ranges.

15. The range detecting apparatus according to claim 14 wherein said detector includes a pixel array having a plurality of groups of pixels, wherein each group includes at least one first pixel configured for accumulation of a first number of pulses out of said first and second series of pulses and at least one second pixel configured for accumulation of a second number of pulses out of said first and second series of pulses.

16. The range detecting apparatus according to claim 15 wherein said detector is configured to detect ambient light prior to said first and second timeslots.

17. The range detecting apparatus according to claim 16 wherein said ambient light is detected with all the pixels in said groups.

18. The range detecting apparatus according to claim 15 wherein each group in said pixel array includes two first pixels for detecting a front portion and a back portion of said first and second pulses and two second pixels for detecting a front portion and a back portion of said first and second pulses.
